(19) United States
(12) Patent Application Publication
(10) Pub. No.: US 2004/0236784 A1
(43) Pub. Date: Nov. 25, 2004

(54) System and method for dynamic management of electronic mail accounts

(76) Inventor: Chiu Chien-Yuan, Hsin Chu (TW)

Correspondence Address: DUANE MORRIS, LLP, IP DEPARTMENT, ONE LIBERTY PLACE, PHILADELPHIA, PA, 19103-7396, US

(21) Appl. No.: 10/442,345

(22) Filed: May 21, 2003

(51) Int. Cl. G06F 15/16; G06F 17/00

(52) U.S. Cl. 707/104.1; 709/206

(57) ABSTRACT

A method and system for dynamically managing a plurality of entries in an electronic database is disclosed. The method comprises providing a status indication of each entry, designated as active, with respect to a known date associated with each entry, the indication representative of providing a notification when a current date is a known period prior to an associated known date, or deferring an entry when a current date is comparable to said associated known date, the deferral inactivating the entry. The method further includes removing each inactivated entry from the database when the current date is comparable to a predetermined period subsequent to the known date. In one aspect, the method further includes, designating an entity as active responsive to a request, the designation further determining said known date. In this aspect, the method further includes assigning an identification to said entity and optionally, assigning an access code.

### FIELD OF THE INVENTION

This application is related to the field of electronic file management and more specifically dynamically managing electronic message transfer, e.g., e-mail, accounts.

### BACKGROUND OF THE INVENTION

The use of electronic mail, i.e., e-mail, has become an essential element of both personal and business communication. The transfer of messages, almost instantaneously, using e-mail has allowed persons to communicate personal messages, greetings, photographs, etc., with little or no effort. The business community, similarly, has embraced electronic transfer of information to efficiently speed communication among its employees. Using e-mail, information among members of a business group, project, or program can quickly and easily be transferred in a timely manner. Hence, by assigning each employee an electronic mail address, for example, the employee name at a known server address, employees may be electronically grouped. E-mail programs such as LOTUS NOTES and MICROSOFT OUTLOOK are well-known in the art of e-mail programs and their operation need not be discussed in detail herein.

In many business settings, temporary employees are used to increase the number of people working on a project or fill gaps in the talent pool of the present employees. For example, technology experts or consultants may be contracted to provide services for a finite period of time. In this case, to integrate the technology expert or consultant into the project or program group, an address to receive and send electronic information must be established. Typically, the Information Technology (IT) system administrator responsible for the management of the e-mail address accounts, upon receiving the necessary information, establishes the consultant's e-mail address. Similarly, when the contract is ended, the IT administrator must remove the e-mail address assigned to the technology expert or consultant for the account to prevent the consultant from obtaining further information. This process of adding and removing e-mail addresses is often a logistical burden as information regarding starting and ending dates of temporary employees must be strictly coordinated to allow access to information when the contract period begins and preclude access to information when the contract period ends. One problem with merely deleting the e-mail address at the end of the contract term is that the contract term may be extended for an additional period, e.g., week, month, etc. Further, these contract term extensions may repeat a number of times as either the business or the consultant may not wish to contract for a significantly longer time. Still another problem is that there may be a gap between the end of one contract and the start of another contract. For example, a consultant at the end of a contract term may take some time off before again providing service to the business or company. In this case, the administrator is required to remove the address at the end of the contract, and later re-establish the address when the contract is re-entered.

Conventionally, the process of adding and removing e-mail addresses is a time-consuming paper-based process where information must be passed between appropriate parties and the system administrator. The system administrator may also need two or three days to establish or remove the address from the e-mail account. Thus, the current methods are slow and burdensome in managing the e-mail address accounts and at times render the account insecure as addresses are not quickly removed.

Accordingly, there is a need for a method and a system for reducing the burden of managing e-mail accounts while expediting the process of adding and removing entries from the accounts.

### SUMMARY OF THE INVENTION

A method and system for dynamically managing a plurality of entries in an electronic database is disclosed. The method comprises providing a status indication of each entry, designated as active, with respect to a known date associated with each entry, the indication representative of providing a notification when a current date is a known period prior to an associated known date, or deferring an entry when a current date is comparable to said associated known date, the deferral inactivating the entry. The method further includes removing each inactivated entry from the database when the current date is comparable to a predetermined period subsequent to the known date. In one aspect, the method further includes, designating an entity as active responsive to a request, the designation further determining said known date. In this aspect, the method further includes assigning an identification to said entity and optionally, assigning an access code.

### BRIEF DESCRIPTION OF THE DRAWINGS

FIG. 1a illustrates a flow chart of a generalized exemplary process flow in accordance with the principles of the invention;

FIG. 1b illustrates a flow chart of an exemplary process flow for controlling the processing in accordance with the principles of the invention;

FIG. 1c illustrates a second flow chart for controlling the processing in accordance with the principles of the invention;

FIG. 2 illustrates a flow chart of a process for initiating an e-mail address in accordance with the principles of the invention;

FIG. 3 illustrates a flow chart of a process for extending an e-mail address in accordance with the principles of the invention;

FIG. 4 illustrates a flow chart of a process for deleting an e-mail address in accordance with the principles of the invention;

FIG. 5 illustrates a flow chart of a process for maintaining an e-mail address after deletion in accordance with the principles of the invention;

FIG. 6a illustrates a flow chart of a process for monitoring the status of e-mail addresses in accordance with the principles of the invention;

FIG. 6b illustrates a flow chart of more specific processing shown in FIG. 6a; and

FIG. 7 illustrates a system for implementing the processes illustrated in FIGS. 1-6.

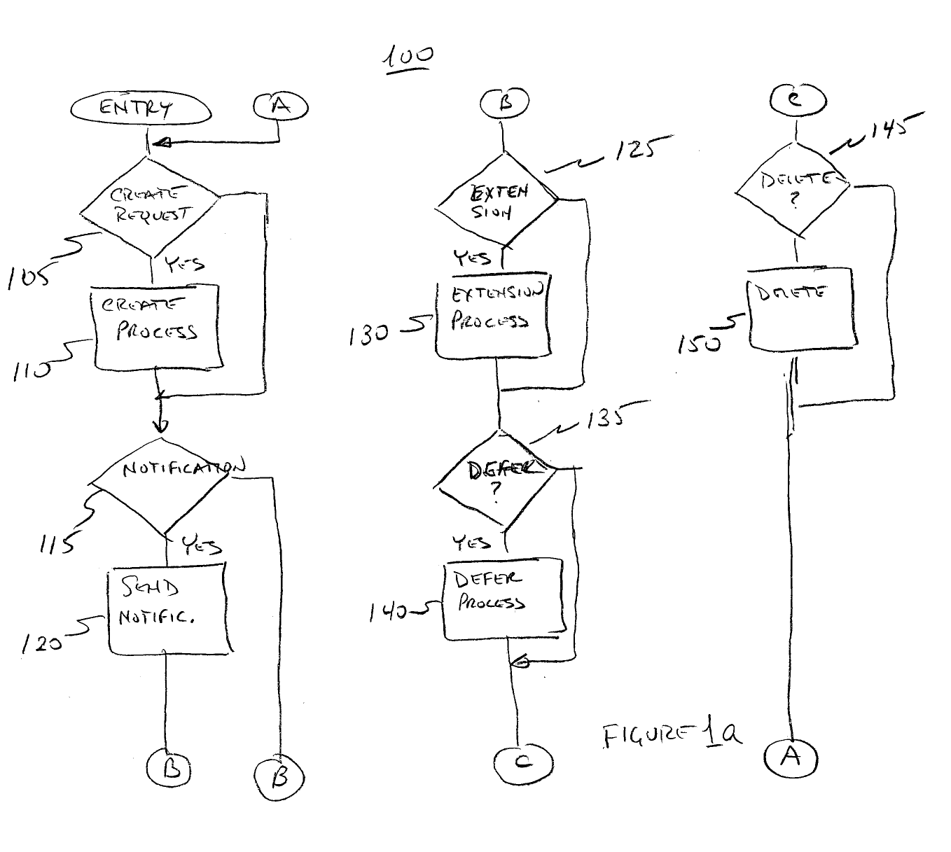

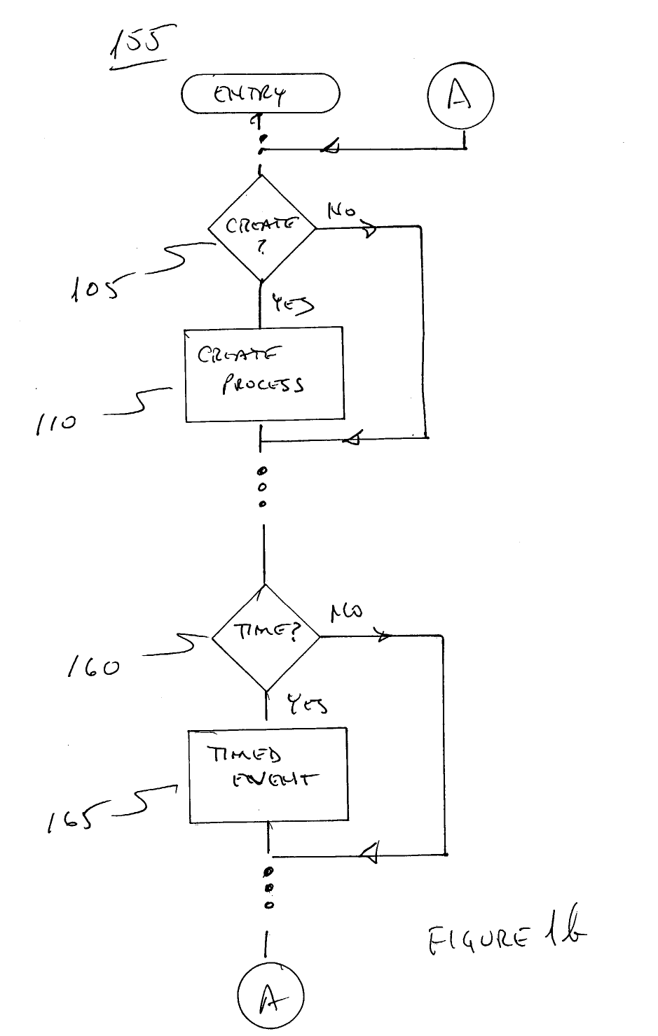

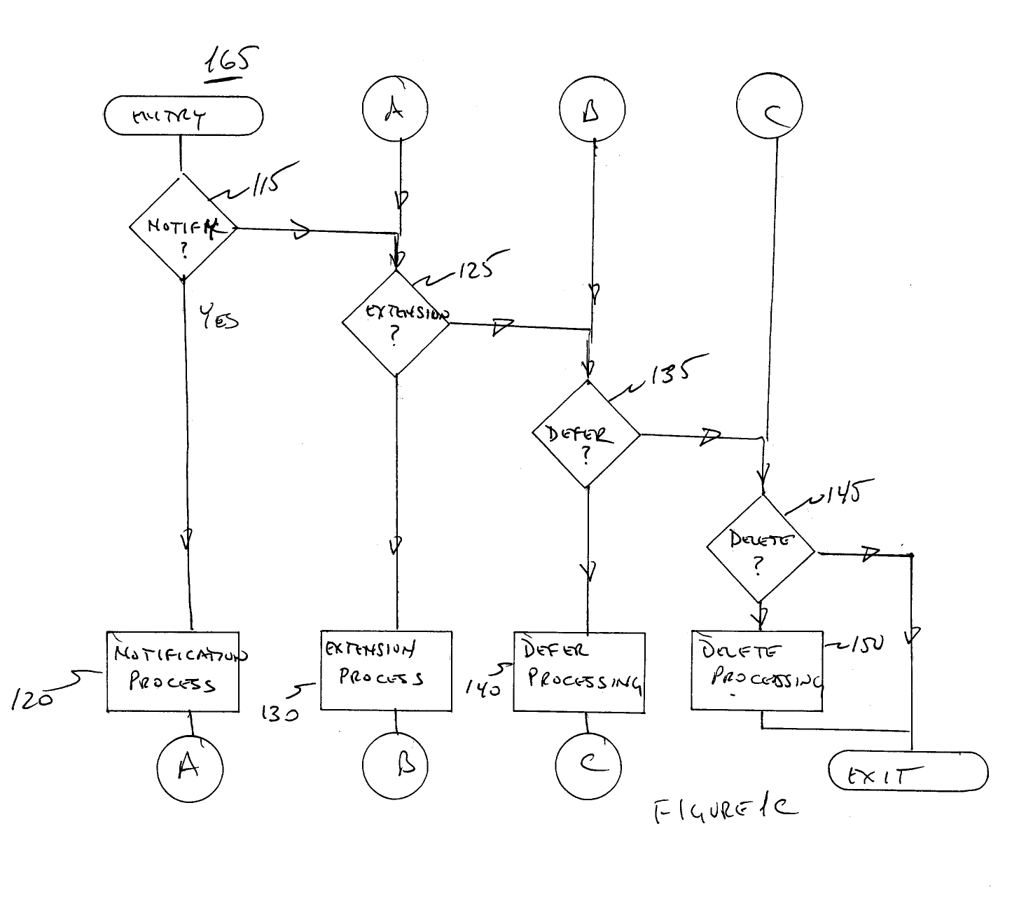

It is to be understood that these drawings are solely for purposes of illustrating the concepts of the invention and are not intended as a definition of the limits of the invention. The embodiments shown in FIGS. 1 through 7 and described in the accompanying detailed description are to be used as illustrative embodiments and should not be construed as the only manner of practicing the invention. Also, the same reference numerals, possibly supplemented with reference characters where appropriate, have been used to identify similar elements.

### DETAILED DESCRIPTION OF THE INVENTION

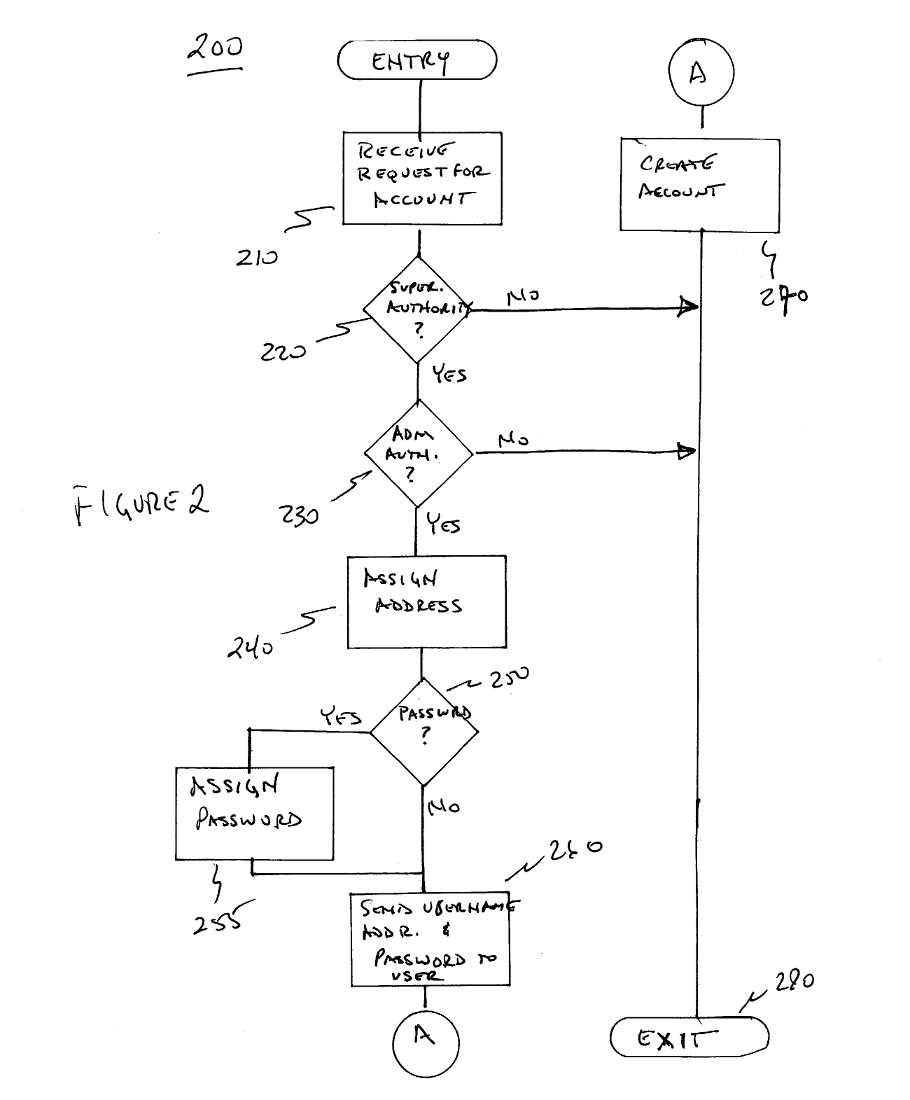

FIG. 1 illustrates a flow chart of an exemplary process 100 for managing entities, for example e-mail addresses or user names, in an electronic database. In this process, a determination is made, at block 105, whether a request to create an entry or entity is made or has been received. If the answer is affirmative, then create entity process is performed at block 110. Create processing is more fully disclosed with regard to FIG. 2.

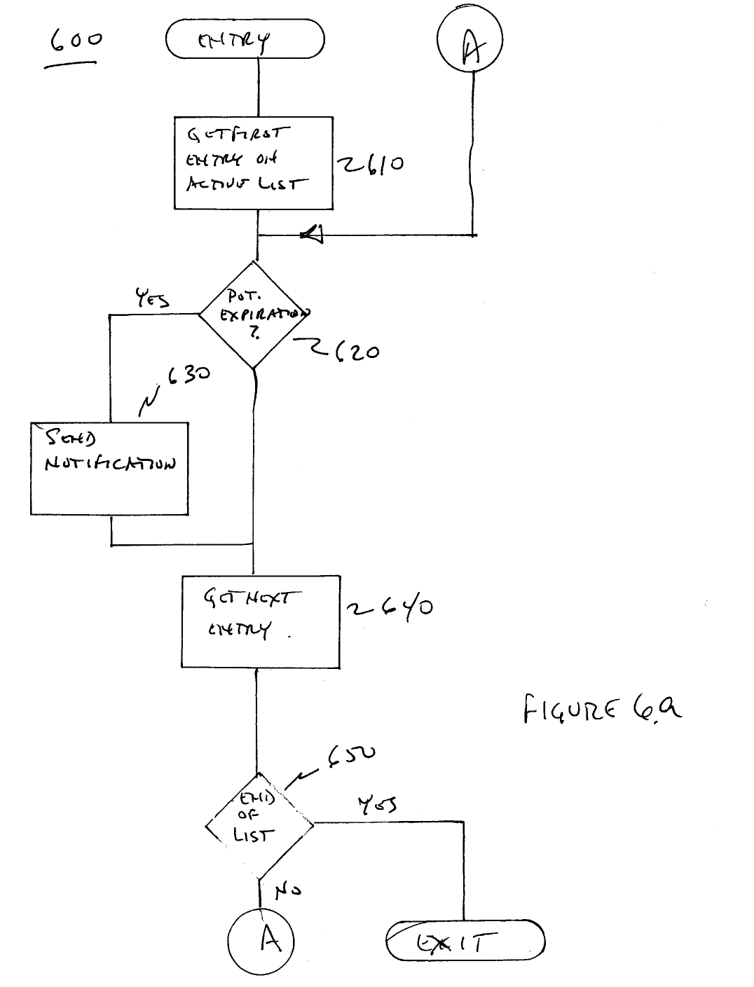

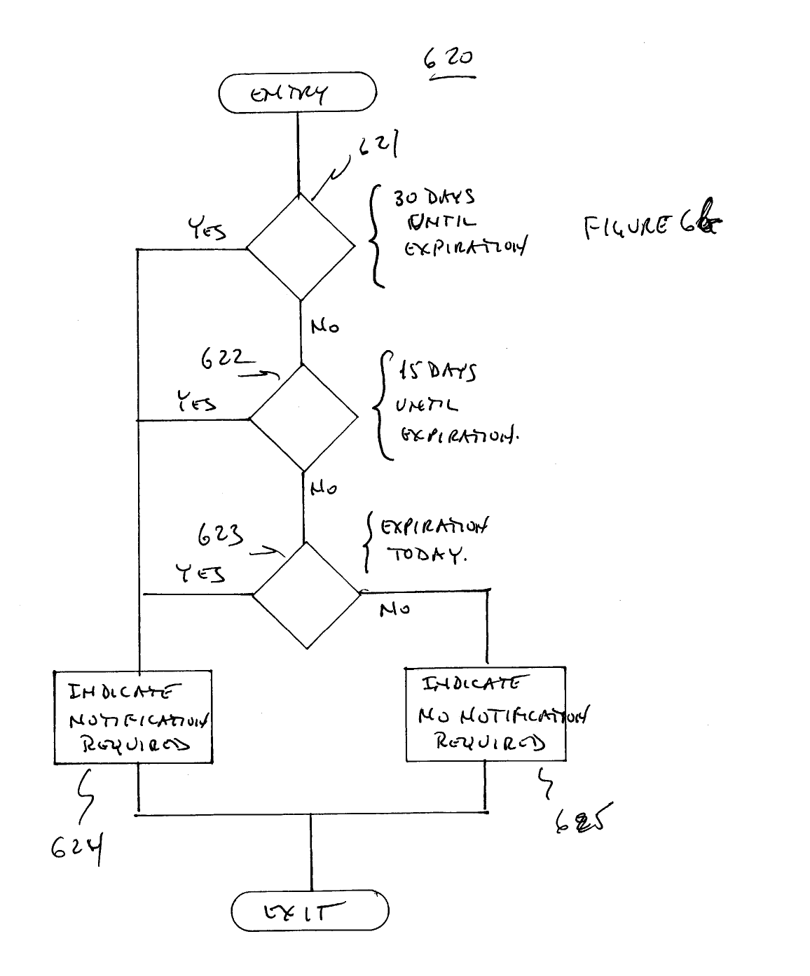

However, if the answer is negative, a determination is made, at block 115, whether notification of the possible removal of an entity is necessary. If the answer is affirmative, then notification process is performed at block 120. Notification processing is more fully disclosed with regard to FIGS. 6a and 6b.

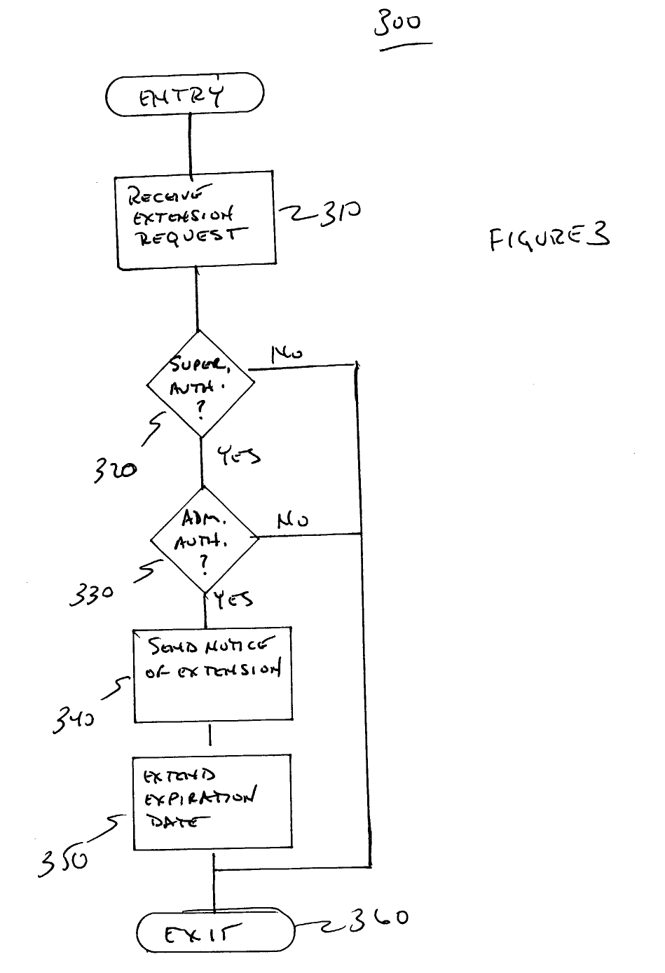

However, if the answer is negative, a determination is made, at block 125, whether a request to extend the duration of an existing entry has been received. If the answer is in the affirmative then extension processing is performed at block 130. Extension processing is more fully disclosed with regard to FIG. 3.

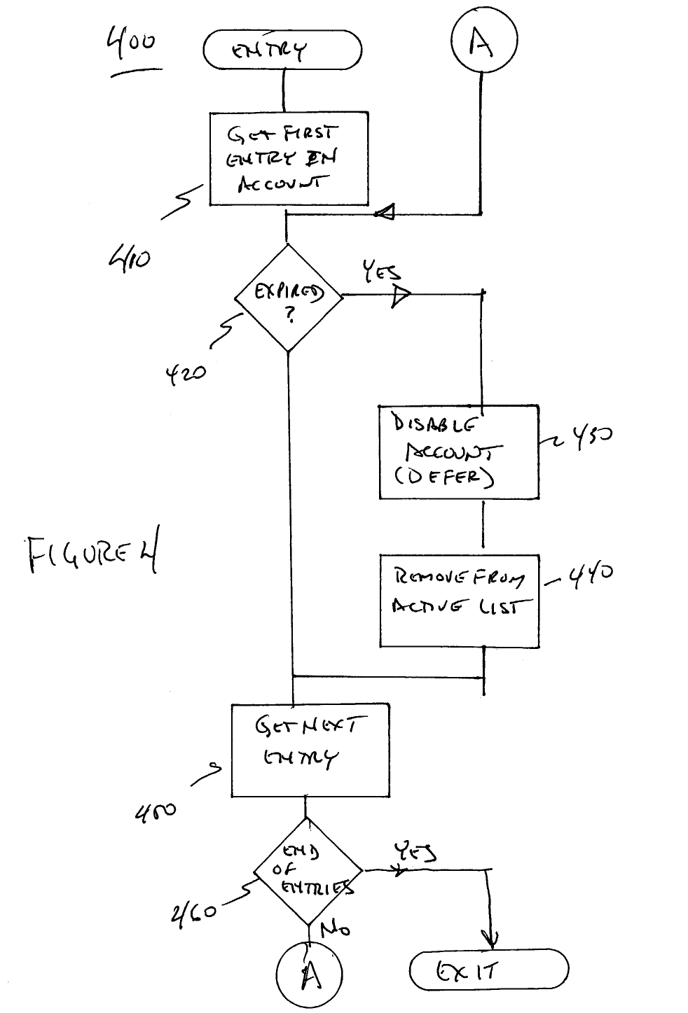

However, if the answer is negative, a determination is made, at block 135, whether the duration of an entity has been reached. If the answer is affirmative, then defer processing is performed at block 140. As one skilled in the art would recognize, defer processing removes an entity from an active status at the expiration of duration of the entity to an inactive status without removing the entity from the database. Defer processing is more fully disclosed with regard to FIG. 4.

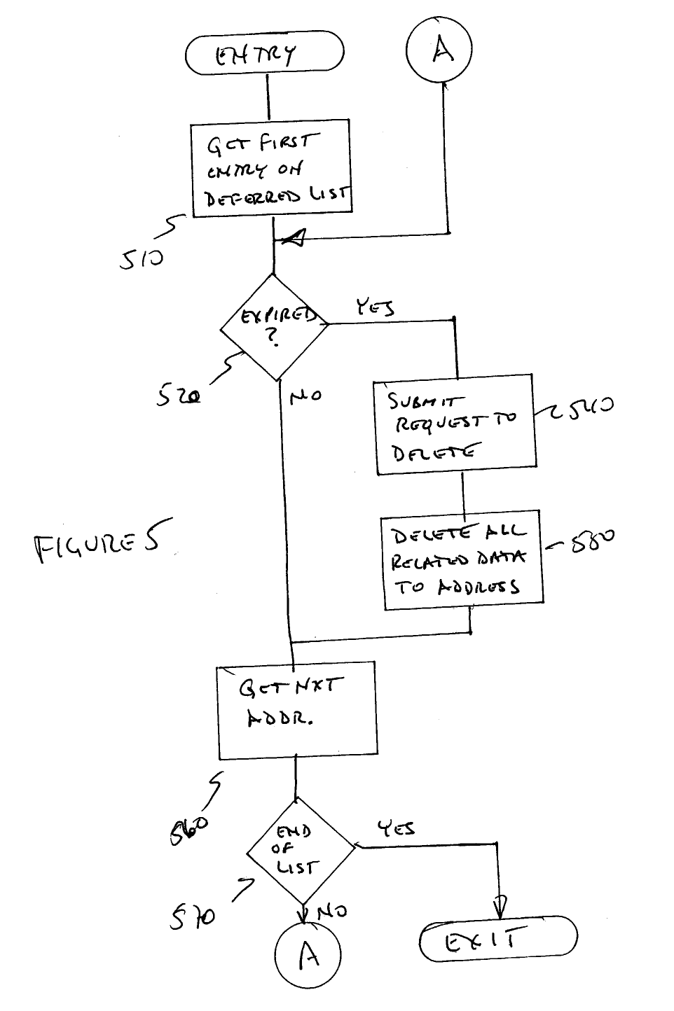

However, if the answer is negative, a determination is made, at block 145, whether an entry is to be removed from the electronic database. If the answer is affirmative, then delete processing is performed at block 150. Delete processing is more fully disclosed with regard to FIG. 5.

As shown, processing then returns to block 105 to determine whether a new create request has been received.

As one skilled in the art would recognize, the cycle shown may be performed on a continuous, periodic or timed based. For example, the exemplary processing shown in FIG. 1 may be continually executed once begun. In another aspect, the processing may be executed a single time on a timed basis, e.g., once per hour, once per day, etc. Furthermore, although the processing is shown in a linear sequence, it would be recognized that notification, deferral and deletion processing may be performed on a timely basis while create processing may be executed when a create request is received, similar to an interrupt process.

FIGS. 1b and 1c more fully disclose processing for controlling the processing of the present invention as described above. For example, FIG. 1b illustrates a flow chart of a cyclic process 155 similar to an operating system, for controlling the processing of the present invention. In this exemplary control process 155, in addition to controlling the processes not within the scope of the present invention, a determination is made at block 105 whether a create function in accordance with the principles of the present invention is required. If the answer is affirmative then create process 110 is performed.

If, however, the answer is negative, then processing continues in the control of other functions or processes within the overall process flow. A determination is then made, at block 160, whether an event based on time is to be executed. If the answer is in the affirmative, then time-event processing is performed at block 165. Control processing then continues and cycles back to the beginning of the control process.

FIG. 1c illustrates a flow chart of an exemplary timed-event process 165 shown in FIG. 1b. In this exemplary process, a determination is made at block 115 whether a notification is required. If the answer is in the affirmative then notification processing is performed at block 120. A determination is then made at block 125 whether extension is required. If the answer is in the affirmative, then extension processing is performed at block 130. A determination is then made at block 135 whether defer processing is required. If the answer is in the affirmative, then defer processing is performed at block 140. A determination is then made at block 145 whether delete processing is required. If the answer is in the affirmative, then delete processing is performed at block 150.

In accordance with the exemplary process 165 shown, each of the processes 120, 130, 140 and 150 may be performed at different rates or at different times. For example, delete processing may be performed once at the end of each day and notification processing may be performed at the beginning and end of each day. Furthermore, one skilled in the art would recognize that the processing, although shown in specific order, need not be performed in the depicted order.

FIG. 2 illustrates a flow chart of an exemplary process 200 for initiating an e-mail address in accordance with the principles of the invention. In this process, an application for a new address is provided to the system administrator at block 210. For example, an application for an e-mail address may be initiated or requested by a supervisor or the temporary employee, i.e., consultant. This request may be provided using a conventional paper-based method or an electronic means. At block 220 a determination is made whether the request has been approved by an appropriate supervising authority. If the answer is negative then processing on the request is concluded. However, if the answer is in the affirmative, then a determination is made at block 230 whether the request has been approved by the appropriate administrative authority. If the answer is negative, then processing is concluded at block 290.

However, if the answer is in the affirmative, then a user name, i.e., address, is established by the administrator at block 240. At block 250, a determination is made whether a security access code or password is required. If the answer is in the affirmative, then a password is assigned at block 255. In one aspect a default password may be assigned which the user may later change. At block 260 the user name and/or security access code are sent to the requestor at block 270. At block 270, the user name and the optional associated password are entered into the account file.

FIG. 3 illustrates a flow chart for an exemplary process 300 for extending the use of a temporary employee e-mail account. In this process, a request for an extension of the use of the selected e-mail account or address or user name is made at block 310. At block 320 a determination is made whether the request has been approved by an appropriate supervising authority. If the answer is negative, then processing on the request is concluded. However, if the answer is in the affirmative, then a determination is made at block 330 whether the request has been approved by the appropriate administrative authority. If the answer is negative then processing is concluded at block 360.

However, if the answer is in the affirmative, then acknowledgement of the extension of the e-mail address is provided to the user at block 340. At block 350, the account file associated with the user name is updated to reflect the status of the approved extension and the entry of a new expiration date.

FIG. 4 illustrates a flow chart of an exemplary process 400 for disabling or deferring an e-mail address or user name in accordance with the principles of the invention. In this process, at block 410 an e-mail address is selected from the plurality of e-mail addresses in the e-mail database or account. At block 420, a determination is made whether the expiration date of the selected e-mail address is not the same as a current date. If the answer is negative, then process is completed on the selected e-mail address and a next address is selected at block 460.

However, if the answer is in the affirmative, then the status of the selected e-mail address is marked as disabled or deferred status at block 430 and the selected address is transferred to a temporary deferred repository at block 440. The date of the deferral is then associated with the deferred e-mail address. A next e-mail address is selected from the plurality of e-mail addresses in the e-mail database at block 450. A determination is then made at block 40 whether all the entries have been processed. If the answer is negative, processing on the selected next entry is begun at block 420.

FIG. 5 illustrates a flow chart of an exemplary process 500 for deleting a deferred e-mail address in accordance with the principles of the invention. In this process, a deferred e-mail address is selected from the e-mail addresses marked as disabled or deferred at block 510. At block 520 a determination is made whether the selected entry is at its assigned expiration date. In one aspect of the invention, the expiration is determined when the current date is greater than a predetermined number of days from the deferral date associated with selected entry. In a preferred embodiment of the invention, a deferred account remains as a deferred account for a period of thirty (30) days. If the answer is negative, then process is completed on the selected e-mail address or user name and a next deferred e-mail address is selected at block 560.

However, if the answer is in the affirmative, then at block 540 an indicator is provided to the administrator to delete the selected account and at block 550 the information items associated with the selected deferred address or user name are deleted from the account file. At block 560, a next deferred e-mail address is selected at block 560 and a determination whether all the entries have been processed is made. If the answer is negative, than processing on the next deferred entry is begun at block 520.

FIG. 6a illustrates a flow chart of an exemplary process 600 for dynamically providing notification of an e-mail address in accordance with the principles of the present invention. In this process, at block 610, an e-mail address is selected from the e-mail addresses in the e-mail database or account. At block 620, a determination is made whether a current date is a predetermined number of days from the expiration date of the selected e-mail address, preferably 30 days. If the answer is in the affirmative then a notification message of the expiration of the e-mail address or user name will be occurring at block 630. Otherwise, processing continues at block 640 to select the next e-mail address. A determination is then made at block 650 whether all of the entries on the active list have been processed. If the answer is in the negative, then processing of the next selected entry is begun at block 620.

FIG. 6b illustrates a flow chart of an exemplary preferred process of a notification process 620. In this exemplary process, a determination is made at block 621 whether the current date is within 30 days of the expiration date of the selected entry. If the answer is in the affirmative, then an indication that notification is necessary is provided at block 624. However, if the answer is negative, then a determination is made at block 622 whether the current date is within 15 days of the expiration date of the selected entry. If the answer is in the affirmative, then an indication that notification is necessary is provided at block 624. However, if the answer is negative, then a determination is made at block 623 whether the current date and the expiration date of the selected entry are the same. If the answer is in the affirmative, then an indication that notification is necessary is provided at block 624. Otherwise, an indication that no notification is necessary is provided at block 625.

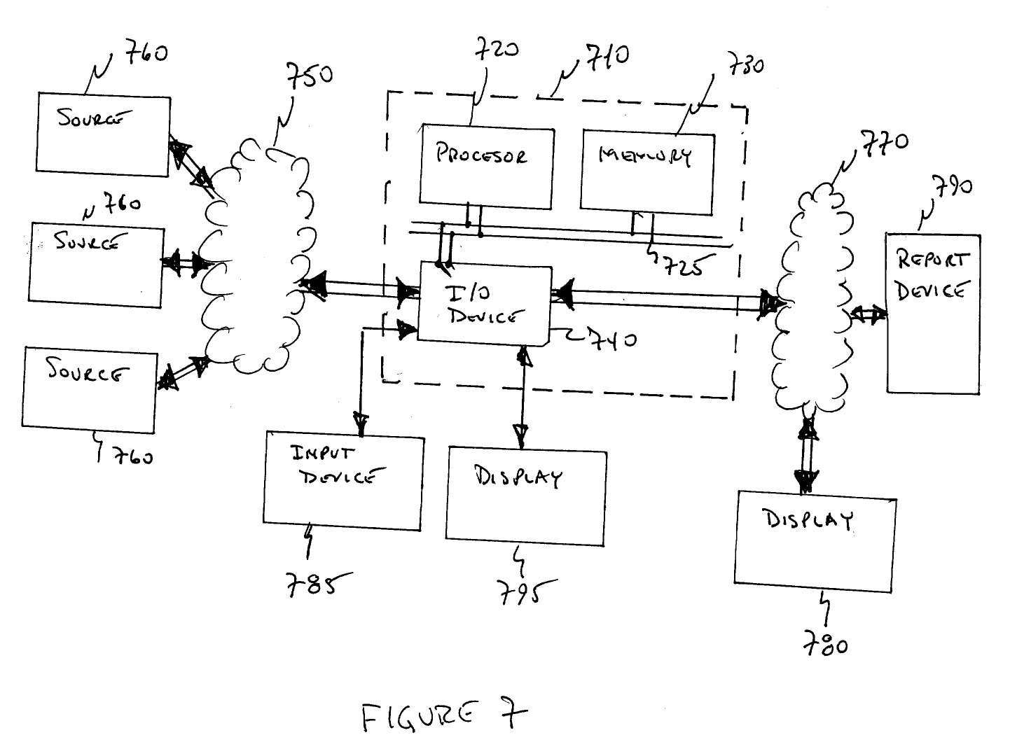

FIG. 7 illustrates a system 700 for implementing the principles of the invention as depicted in the exemplary processing shown in FIGS. 1-6. In this exemplary system embodiment 700, input data is received over network 750 and is processed in accordance with one or more software programs executed by processing system 710. The results of processing system 710 may then be transmitted over network 770 for viewing on display 780 and/or reporting device 790.

More specifically, processing system 710 includes one or more input/output devices 740 that receive data from the illustrated source devices 760 over network 750. The received data is then applied to processor 720, which is in communication with input/output device 740 and memory 730. Input/output devices 740, processor 720 and memory 730 may communicate over a communication medium 725. Communication medium 725 may represent a communication network, e.g., ISA, PCI, PCMCIA bus, one or more internal connections of a circuit, circuit card or other device, as well as portions and combinations of these and other communication media. Processor 720 may be representative of a handheld calculator, special purpose or general purpose processing system, desktop computer, laptop computer, palm computer, or personal digital assistant (PDA) device, etc., as well as portions or combinations of these and other devices that can perform the operations illustrated in FIGS. 1-6.

In one embodiment, processor 720 may include code which, when executed, performs the operations illustrated herein. The code may be contained in memory 730, read/downloaded from a memory medium such as a CD-ROM or floppy disk (not shown), or provided by manual input device 785, such as a keyboard or a keypad entry or may read data from a magnetic or optical medium which is accessible by processor 720, when needed. Information items provided by input device 785 and/or memory medium may be accessible to processor 720 through input/output device 740, as shown. Further, the data received by input/output device 740 may be immediately accessible by processor 720 or may be stored in memory 730. Processor 720 may further provide the results of the processing shown herein to display 795 through I/O device 740.

As one skilled in the art would recognize, the term processor, processing system, computer or computer system may represent one or more processing units in communication with one or more memory units and other devices, e.g., peripherals, connected electronically to and communicating with the at least one processing unit. Furthermore, the devices may be electronically connected to the one or more processing units via internal busses, e.g., ISA bus, microchannel bus, PCI bus, PCMCIA bus, etc., or one or more internal connections of a circuit, circuit card or other device, as well as portions and combinations of these and other communication media, or an external network, e.g., the Internet and Intranet. In other embodiments, hardware circuitry may be used in place of, or in combination with, software instructions to implement the invention. For example, the elements illustrated herein may also be implemented as discrete hardware elements or may be integrated into a single unit.

As would be understood, the operations illustrated in FIGS. 1-6 may be performed sequentially or in parallel using different processors to determine specific values. Processor system 710 may also be two-way communication with each of the sources 760 to provide the results of the operations regarding the status of the electronic addresses and accounts. Processor system 710 may further receive or transmit data over one or more network connections from a server or servers over, e.g., a global computer communications network such as the Internet, Intranet, a wide area network (WAN), a metropolitan area network (MAN), a local area network (LAN), a terrestrial broadcast system, a cable network, a satellite network, a wireless network, or a telephone network (POTS), as well as portions or combinations of these and other types of networks. As will be appreciated, networks 750 and 770 may also be internal networks, e.g., ISA bus, microchannel bus, PCI bus, PCMCIA bus, etc., or one or more internal connections of a circuit, circuit card or other device, as well as portions and combinations of these and other communication media or an external network, e.g., the Internet and Intranet.

While there has been shown, described, and pointed out fundamental novel features of the present invention as applied to preferred embodiments thereof, it will be understood that various omissions and substitutions and changes in the apparatus described, in the form and details of the devices disclosed, and in their operation, may be made by those skilled in the art without departing from the spirit of the present invention. It is expressly intended that all combinations of those elements that perform substantially the same function in substantially the same way to achieve the same results are within the scope of the invention. Substitutions of elements from one described embodiment to another are also fully intended and contemplated.

What is claimed is:

1. A method for dynamically managing a plurality of entries in an electronic database comprising the steps of:
providing a status indication of each of said entries, designated as active, with respect to a known date associated with each of said entries, said indication representative of a notification when a current date is a known period prior to said associated known date; or
deferring said entry when a current date is comparable to said associated known date, said deferral inactivating said entry.

2. The method as recited in claim 1, further comprising the step of:
removing each of said inactivated entries from said database when said current date is comparable to a predetermined period subsequent to said known date.

3. The method as recited in claim 1, further comprising the steps of:
responsive to a request:
designating an entry as active when said entry is indicated as inactive;
otherwise, creating said entry and designating said entry as active; and
determining said associated known date.

4. The method as recited in claim 3, wherein the step of designating an entry as active further includes the step of:
assigning an identification to said entry.

5. The method as recited in claim 4, wherein the step of designating an entry as active further includes the step of:
assigning an access code.

6. The method as recited in claim 3, wherein said known date is selected from the group consisting of: a predetermined date, a predetermined period with respect to said request.

7. The method as recited in claim 1, wherein said known period is selected in the range of 0-60 days.

8. The method as recited in claim 7, wherein said known period is selected from the group of days consisting of: 30, 15, 0.

9. The method as recited in claim 2, wherein said predetermined period is selected in the range of 0-60 days.

10. The method as recited in claim 1, wherein said notification includes said known date.

11. The method as recited in claim 1, wherein said notification provides an indication of a period remaining until said known date.

12. The method as recited in claim 1, wherein said database is associated with an electronic mail system.

13. The method as recited in claim 13, wherein said electronic mail system is selected from the group consisting of: LOTUS NOTES, OUTLOOK, ENDORA.

14. A system for dynamically managing a plurality of entries in an electronic database comprising:
a processor in communication with a memory, said processor operable to execute code for:
providing a status indication of each of said entries, designated as active, with respect to a known date associated with each of said entries, said indication representative of a notification when a current date is a known period prior to said associated known date; or
deferring said entry when a current date is comparable to said associated known date, wherein said deferral inactivates said entry.

15. The system as recited in claim 14, wherein said processor is further operate to execute code for:
removing each of said inactivated entries from said database when said current date is comparable to a predetermined period subsequent to said known date.

16. The system as recited in claim 14, wherein said processor is further operate to execute code for:
responding to a request:
extending an entry by designating said entry as active when said entry is inactivity;
otherwise, creating an entry and designating said entry as active; and
determining said associated known date.

17. The system as recited in claim 16, wherein said code for designating an entry as active further includes code for:
assigning an identification to said entry.

18. The system as recited in claim 17, wherein said code for designating an entry as active further includes code for:
assigning an access code.

19. The system as recited in claim 15, wherein said known date is selected from the group consisting of: a predetermined date, a predetermined period with respect to said request.

20. The system as recited in claim 14, wherein said known period is selected in the range of 0-60 days.

21. The system as recited in claim 20, wherein said known period is selected from the group of days consisting of: 30, 15, 0.

22. The system as recited in claim 16, wherein said predetermined period is selected in the range of 0-60 days.

23. The system as recited in claim 14, wherein said notification includes said associated known date.

24. The system as recited in claim 14, wherein said notification a period remaining until said associated known date.

25. The system as recited in claim 14, wherein said database is associated with an electronic mail system.

26. The system as recited in claim 25, wherein said electronic mail system is selected from the group consisting of: LOTUS NOTES, OUTLOOK, ENDORA.

27. The system as recited in claim 14, wherein said code is stored in said memory.

28. The system as recited in claim 14, further comprising:
a input/output device in communication with said processor, said input/output device operable to receive and transmit information between said processor an at least one network.

29. The system as recited in claim 28, wherein said information is selected from the group consisting of: notification, request, deferral, deletion.

30. The system as recited in claim 29 wherein said request is selected from the group consisting of: extension, create.
